(19) United States
(12) Patent Application Publication
(10) Pub. No.: US 2026/0093008 A1
(43) Pub. Date: Apr. 2, 2026

(54) DECOUPLING-BASED LOW-COMPLEXITY METHOD FOR SCATTER SIGNATURE ESTIMATION IN THE WIDEBAND MULTI-ANTENNA MULTI-CARRIER SYSTEMS.

(71) Applicant: INDIAN INSTITUTE OF TECHNOLOGY KHARAGPUR, Kharagpur (IN)

(72) Inventors: Chandrashekhar Rai, Kharagpur (IN); Prof. Debarati Sen, Kharagpur (IN)

(73) Assignee: INDIAN INSTITUTE OF TECHNOLOGY KHARAGPUR, Kharagpur, WB (IN)

(21) Appl. No.: 19/052,191

(22) Filed: Feb. 12, 2025

(30) Foreign Application Priority Data
Sep. 30, 2024 (IN) 202431073729

(51) Int. Cl. G01S 5/22; G01S 5/02; H04L 25/02

(52) U.S. Cl. CPC G01S 5/22; G01S 5/0268; H04L 25/0212

(57) ABSTRACT

The present invention provides a method for low-complex estimation of Direction of Arrival (DoA) and Time of Arrival (ToA) in multi-antenna-based communication comprising detecting overlapped paths between a Mobile Station (MS) and a Base Station (BS) operating under said multi-antenna-based communication with scatters present therein involving channel paths represented as Channel Impulse Response (CIR) defined with channel signatures including delay and angle steering vectors, decoupling the channel paths in delay and angle-domain and separately estimate the DoA and ToA of each path with a low computational complexity which is based on one-dimensional low-index based rotation methodology and finally pairing the DoA and the ToA.

### RELATED APPLICATIONS

This application claims priority to India patent application No. 202431073729, Filing Date Sep. 30, 2024, entitled A DECOUPLING-BASED LOW-COMPLEXITY METHOD FOR SCATTER SIGNATURE ESTIMATION IN THE WIDEBAND MULTI-ANTENNA MULTI-CARRIER SYSTEMS; which is incorporated herein by reference in its entirety.

### FIELD OF THE INVENTION

The present invention relates to the 6G location-based wireless communication services. More specifically, the present invention is directed to provide method and system for low-complexity target/scatter detection and the corresponding parameter estimations of a sparse radio scene for the next-generation GigaHertz (GHz) ex. millimeter-wave (mmWave)/TeraHertz (THz) massive multi-antenna communication systems with the significant spatial wideband effects.

### BACKGROUND OF THE INVENTION

The wireless communication signals can also be used for the analysis of the radio channel through the Channel Impulse Response (CIR) measurements. In this context, the band of operations at the mmWave/THz frequencies offer an enormous BandWidth (BW) enabling a massive number of antennae to be fabricated over smaller physical apertures. This in turn provides the opportunity to analyze a radio channel via detecting the number of scatters present in the environment with a high-resolution estimation of corresponding Direct of Arrival (DoA) and Time of Arrival (ToA) parameters,

| Related Prior Arts | Teachings |
|---|---|
| Sun, X., Gao, X., Li, G. Y., & Han, W. (2018). | MIMO-OFDM systems |
| Single-site localization based on a new type of | SWE is not considered |
| fingerprint for massive MIMO-OFDM systems. | Fingerprinting-based method |
| IEEE Transactions on Vehicular Technology, | Require offline fingerprint |
| 67(7), 6134-6145 | collection |
| Wang, B., Gao, F., Jin, S., Lin, H., & Li, G. Y. | SWE is considered |
| (2018). Spatial-and frequency-wideband | Rotation-based DoA-ToA estimates |
| effects in millimeter-wave massive MIMO systems. | No specific clustering |
| IEEE Transactions on Signal Processing, | mechanism is given |
| 66(13), 3393-3406 | Bin shifting due to SWE is not |
| | considered |
| | Overlapped paths are considered |
| Jian, M., Gao, F., Tian, Z., Jin, S., & Ma, S. | SWE is considered |
| (2019). Angle-domain aided UL/DL channel | SBL-based DoA-ToA estimation |
| estimation for wideband mmWave massive | Very high Computational |
| MIMO systems with beam squint. | Complexity |
| IEEE transactions on wireless communications, | |
| 18(7), 3515-3527. | |
| Liu, S., Gao, Z., Zhang, J., Di Renzo, M., & | Compressive sensing-based |
| Alouini, M. S. (2020). Deep denoising neural | channel estimation for IRS systems |
| network assisted compressive channel estimation | Complex-valued DnCNN is |
| for mmWave intelligent reflecting surfaces. | utilized for removing sampling |
| IEEE Transactions on Vehicular Technology, | noise and enhancing the estimation |
| 69(8), 9223-9228. | SWE is not considered |
| | DoA-ToA is not estimated |
| Weng, S., Jiang, F., & Wymeersch, H. | ESPRIT based method |
| (2023). Wideband mmwave massive mimo | Decoupled method |
| channel estimation and localization. | Path pairing required |
| IEEE Wireless Communications Letters, | SWE is considered |
| 12(8), 1314-1318. | Overlapped path not considered |
| | High Complexity |
| Liang, J., & Liu, D. (2010). Joint elevation | L-Shaped Array is considered |
| and azimuth direction finding using L-shaped array. | SWE is not considered |
| IEEE Transactions on Antennas and Propagation, | Path pairing is not required |
| 58(6), 2136-2141. | Low Complexity |
| Zhang, Z., Wang, W., Huang, Y., & Liu, S. | L-Shaped Array is considered |
| (2017). Decoupled 2-D direction of arrival | SWE is not considered |
| estimation in L-shaped array. | Path pairing is not required |
| IEEE Communications Letters, | Low Complexity |
| 21(9), 1989-1992. | |
| Wang, B. H., Hui, H. T., & Leong, M. S. | UCA is considered |
| (2009). Decoupled 2D direction of arrival | Decoupled method |
| estimation using compact uniform circular | Pairing is not required |
| arrays in the presence of elevation- | 2D DoA Estimation |
| dependent mutual coupling. | SWE is not considered |
| IEEE Transactions on Antennas and Propagation, | |
| 58(3), 747-755, | |
| Rappaport, Theodore S. “System, method | mmWave radio device based |
| and computer-accessible medium for real | imaging system |
| time imaging using a portable device.” | real-time DoA-ToA estimation is |
| U.S. Pat. No. 11,624,821. 11 Apr. 2023. | addressed |
| | SWE is not considered |
| Pajovic, Milutin, et al. “Localization using | mmWave beam-training based method |
| millimeter wave beam attributes.” | requires offline training for |
| U.S. Pat. No. 11,122,397. 14 Sep. 2021. | fingerprinting |
| | SWE is not considered |

The traditional wideband wireless systems and the standards assume the spatial narrowband condition for multi antenna multi carrier systems and deals with the temporal-only wideband effects. However, using a wider fractional BW around the mmWave/THz frequencies along with the massive number of antenna elements poses the condition of non-negligible delays across the array aperture in comparison to the symbol duration that restricts the spatial narrowband assumption and gives raise to the spatial wideband systems. Hence, the measured space-frequency CIR in a multi-antenna multi-carrier system exhibits Spatial Wideband Effect (SWE) in different domains-dual wideband effect in the angle-delay domain, beam squint effect in the angle-frequency domain, and delay-squint effect in the space-delay domain. Therefore, estimating the channel parameters and localizing the scatters of a radio scene with the spatial wideband systems need separate mechanisms than the conventional temporal-only wideband multi-antenna multi-carrier systems. Only a few studies recently discuss about the DoA-ToA estimations of multi-antenna multi carrier communication systems with spatial wideband assumption. Moreover, due to the spatial wideband effect, the delay-angle signatures of the two or more nearby scatters can overlap with each other and further restricts them to be discernible by the conventional methods. Though it is important to identify such overlapping paths, to the best of our knowledge, none of the existing works suggest the method to detect these overlapped path signatures in a spatial wideband system.

### OBJECT OF THE INVENTION

It is thus the basic object of the present invention is to develop a method and system for low-complexity target/scatter detection and the corresponding Direct of Arrival (DoA) and Time of Arrival (ToA) parameter estimations of a sparse radio scene for the next-generation GigaHertz (GHZ) ex. millimeter-wave (mmWave)/TeraHertz (THz) multi-antenna communication systems with the significant spatial wideband effects.

Another object of the present invention is to develop a method and system for decoupled low-index based detection overlapped paths between a Mobile Station (MS) and a Base Station (BS) operating under multi-antenna-based communication.

Yet another object of the present invention is to develop a novel decoupled path DoA-ToA estimation methodology of spatial narrowband-temporal wideband systems.

### SUMMARY OF THE INVENTION

Thus, according to the basic aspect of the present invention there is provided a method for low-complex estimation of Direction of Arrival (DoA) and Time of Arrival (ToA) in multi-antenna-based communication comprising
detecting overlapped paths between a Mobile Station (MS) and a Base Station (BS) operating under said multi-antenna-based communication with scatters present therein involving channel paths represented as Channel Impulse Response (CIR) defined with channel signatures including delay and angle steering vectors;
decoupling the channel paths in delay and angle-domain and separately estimate the DoA and ToA of each path with a low computational complexity which is based on one-dimensional low-index based rotation methodology; and
pairing the DoA and the ToA.

In the above method, the CIR is represented as:
for spatial narrowband-temporal wideband systems

$$H = {{\sum }_{l = 1}}^{L} {\tilde{β}}_{l} c ( {\tilde{θ}}_{l} ) d ( {\tilde{τ}}_{l} ) \qquad ( 1 )$$

where, \tilde{β}ᵢ is the equivalent complex path gain; and
for spatial wideband-temporal wideband systems

$$H = {{\sum }_{l = 1}}^{L} {\tilde{β}}_{l} c ( {\tilde{θ}}_{l} ) d ( {\tilde{τ}}_{l} ) oS ( α , {\tilde{θ}}_{l} ) \qquad ( 2 )$$

where, α is the BW selection parameter around the carrier frequency and S(α, \tilde{θ}ₗ)≙

$$exp ( - j 2 π \frac{α}{N} {\tilde{θ}}_{l} rn )$$

is the wideband phase shift matrix and o denotes the element-wise product between matrix elements.

In the above method, the decoupling the channel paths includes
transforming the CIR into an angle-frequency domain by taking IDFT w.r.t. space domain (d) for the DoA estimates;
transforming the CIR into Space-Delay domain by taking IDFT w.r.t. frequency domain (n), which enables delay diversity combining and the ToA estimation.

In the above method, the decoupling the channel paths in spatial narrowband-temporal wideband model includes
involving the CIR which is in space-frequency domain and applying the IDFT across all rows i.e., across the antenna domain to get the A-F CIR;
picking a lower subcarrier index and finding bins corresponding to the peaks present in the spectrum for coarse DoA angle estimates;
fine tuning each detected DoA angle via 1D rotation method;
involving the IDFT by picking the corresponding row from the angle-frequency CIR and detecting the peaks in the delay spectrum to estimate the coarse ToA delay bins;
fine tuning the ToA delays using 1D rotation method and pair all the detected ToA delays with the DoA angle estimates.

In the above method, the decoupling the channel paths in spatial wideband model includes detection similar to the spatial narrowband-temporal wideband model except to avoid squinting effect by involving lower antenna index.

According to another aspect in the present invention there is provided a system for low-complex estimation of Direction of Arrival (DoA) and Time of Arrival (ToA) in multi-antenna-based communication implementing the above method in spatial narrowband scenario comprises
decoupled angle estimator (606) and delay estimator (607) configured to operate in combination with processing blocks (601-605) that provides the space-frequency CIR;
said decoupled angle estimator (606) includes
   IDFT block (606-01) for IDFT across all the rows i.e., across the antenna domain to get the A-F CIR,
   subcarrier indexing block (606-02) to pick a lower subcarrier index and find the bins corresponding to the peaks present in the IDFT spectrum for coarse angle estimates;
said delay estimator (607) which is configured for finding the delay estimates for each angle estimates includes
   tuner block (607-01) to fine tune the detected angle estimates via 1D rotation method;
   IDFT block (607-02) to take the IDFT by picking the corresponding row from the angle-frequency CIR and detect the peaks in the delay spectrum to estimate the coarse delay bins;
   tuner block (607-03) to fine tune the delays using 1D rotation method; and
   pairing block (607-04) to pair all the detected delays with the current angle.

According to another aspect in the present invention there is provided a system for low-complex estimation of Direction of Arrival (DoA) and Time of Arrival (ToA) in multi-antenna-based communication implementing the above method in spatial narrowband scenario comprises
processing blocks similar to the angle detection for the spatial narrowband along with lower antenna index block (706) to avoid squinting effect;
delay estimator (707) having
   fine tuner block (707-01) to fine-tune angle estimate for every detected angle bin through 1D-rotation;
   conjugating unit (707-02) for conjugating the fine-tuned angle estimate with the spatial wideband effect very closely to get correct DoA-ToA signatures which corresponds to wideband removed space-frequency response;
   IDFT unit (707-03) to take the IDFT across the row of the current angle bin to get the angle-frequency CIR;
   IDFT unit (707-04) to take the IDFT across the column of the detected angle bin and find the peaks for the coarse delay estimates;
   fine tuner (707-05) to implement the 1D rotation-based fine tuning for each delay; and
   pairing unit (707-06) for pairing the fine-tuned delay with the current angle.

### BRIEF DESCRIPTION OF THE DRAWINGS

FIG. 1: A ULA-based system model for signature estimation.

FIG. 2: Channel transformations among different domains.

FIG. 3: Beam squint in spatial wideband-temporal wideband systems.

FIG. 4: Delay squint in spatial wideband-temporal wideband systems.

FIG. 5: Dual wideband spread in spatial wideband-temporal wideband systems.

FIG. 6: Proposed decoupled angle-delay estimation method for spatial narrowband-temporal wideband systems.

FIG. 7: Proposed decoupled angle-delay estimation for spatial wideband-temporal wideband systems.

FIG. 8: Channel path detection (a) 2D input paths (b) Paths detected in the angular spectrum-75, 100 (c) Delay paths detected in the first angular bin-13, 26 (d) Delay paths detected in the second angular bin-31.

FIG. 9: Channel path cluster (a) Non-Overlapped paths (b) Overlapped paths.

FIG. 10: Channel path estimation in spatial wideband system (a) Detected two angle bins-75, 100 (b) Detected two delay bins-13, 16 for the first angular bin 75 (c) Detected one delay bin-31 for the second angular bin 100.

FIG. 11: MSE in DoA-ToA for spatial narrowband-temporal wideband system.

FIG. 12: MSE in Path Complex Coefficient for spatial narrowband-temporal wideband system.

FIG. 13: MSE in DoA-ToA for spatial wideband-temporal wideband system.

FIG. 14: MSE in Path Complex Coefficient for spatial wideband-temporal wideband system.

FIG. 15: MSE in DoA-ToA for spatial wideband-temporal wideband system.

FIG. 16: MSE in Path Complex Coefficient for spatial wideband-temporal wideband system.

### DETAILED DESCRIPTION OF THE INVENTION

In current invention, a decoupled low-index based approach is presented that detects the overlapped paths and yields the Direction of Arrival (DoA)—Time of Arrival (ToA) estimates of a spatial wideband system with low computational complexity. Due to the proposed low-index method, it can easily handle the spatial wideband effect and automatic path pairing is done.

### System Model:

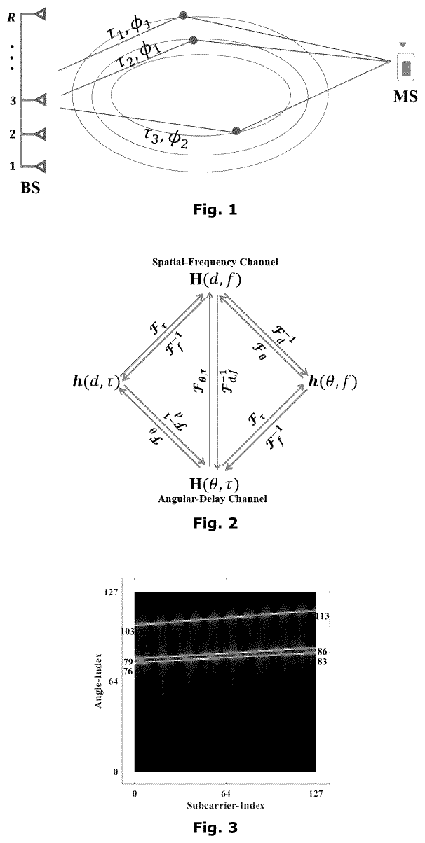

Let there are L point scatters present in the radio scene between a Mobile Station (MS) and a Base Station (BS) as shown in FIG. 1 with the channel signature {\tilde{β}ₗ, \tilde{θ}ₗ, \tilde{τ}ₗ, L}. By defining the delay and angle steering vectors as d(\tilde{τ}^{l})≙[1^{ej2πτ}^{ₗ} . . . e^{ej2π(N-1)τ}^{ₗ}]^{T} and c(\tilde{θ}ₗ)=[1^{ej2πθ}^{ₗ} . . . e^{ej2π(R-1)θ}^{ₗ}]^{T} respectively, the noise-free vector equivalent of the sampled spatial narrowband-temporal wideband Channel Impulse Response (CIR) is

$$H = {{\sum }_{l = 1}}^{L} {\tilde{β}}_{l} c ( {\tilde{θ}}_{l} ) d ( {\tilde{τ}}_{l} ) \qquad ( 1 )$$

Where, \tilde{β}ₗ is the equivalent complex path gain.

On the other hand, the vector equivalent of the sampled spatial wideband-temporal wideband Channel Impulse Response (CIR) is

$$H = {{\sum }_{l = 1}}^{L} {\tilde{β}}_{l} c ( {\tilde{θ}}_{l} ) d ( {\tilde{τ}}_{l} ) oS ( α , {\tilde{θ}}_{l} ) \qquad ( 2 )$$

where, α is the BW selection parameter around the carrier frequency and S(α, \tilde{θ}ₗ)≙

$$exp ( - j 2 π \frac{α}{N} {\tilde{θ}}_{l} rn )$$

is the wideband phase shift matrix and o denotes the element-wise product between the matrix elements.

Spatial Wideband Effects: It can be noticed that for a high BW selection parameter α≥0.05, the symbol duration is quite less so that the spatial propagation delay of a path across the array aperture of massive antenna-size R is non-negligible and the spatial narrowband assumption does not hold true anymore. Due to the spatial wideband effects, extra phase shift matrix S(α, \tilde{θ}ₗ) in the space-frequency channel model appears and every path spreads in the delay-angle domain based on α, \tilde{θ}ₗ. Moreover, it is highly like in a close-range environment that the two paths can overlap with each other due to the SWE. Under this condition, the path detection and DoA-ToA estimation cannot be done directly by identifying the path clusters. In this disclosure, we propose the channel path decoupling in delay and angle-domain and separately estimating the automatically paired DoA and ToA of each path with a low computational complexity. Nonetheless, the low complexity on grid methods will always face the spectral leakage effect and to handle that we are proposing a one-dimensional low-index based rotation methodology.

### Spatial Wideband Effects in Different Domains:

As shown in FIG. 2, channel response can be transformed via FT relations in different domains and processed accordingly. In this invention, we are using different domains for the different motives. Next, we observe the effects of non-negligible spatial delays in the different domains.

### Angle-Frequency Domain: Beam Squint Effect

We can transform the channel Space-Frequency response to the Angle-Frequency domain by taking IDFT w.r.t. space domain (d). Due to the angular sparsity, this beam-space domain channel is heavily utilized at mmWave/THz frequencies in conventional MIMO systems. However, this cannot be directly utilized in the spatial wideband MIMO systems as the channel angular response is not constant for the entire BW range. In an Orthogonal Frequency Division Multiplexing (OFDM) system with spatial wideband assumption, the DoA differs for a different set of subcarriers for a path.

An example of this beam squinting for three paths is shown in FIG. 3 where it can be seen that the path-1 squints from 76 bin to 83 bin, the path-2 squints from 79 bin to 86 bin, and the path-3 squints from 103 bin to 113 bin.

### Space-Delay Domain: Delay Squint Effect:

We can transform the channel Space-Frequency response to the Space-Delay domain by taking IDFT w.r.t. frequency domain (n), which enables delay diversity combining and ToA estimation. In the spatial wideband MIMO systems, the delay corresponding to a particular path is not the same across all the antennas.

It is shown in FIG. 4 that the three paths experience the delay squint-path-1 squints from 13 bin to 20 bin, path-2 squints from 26 bin to 33 bin, and path-3 squints from 52 bin to 62 bin.

### Angle-Delay Domain: Dual Wideband Effect

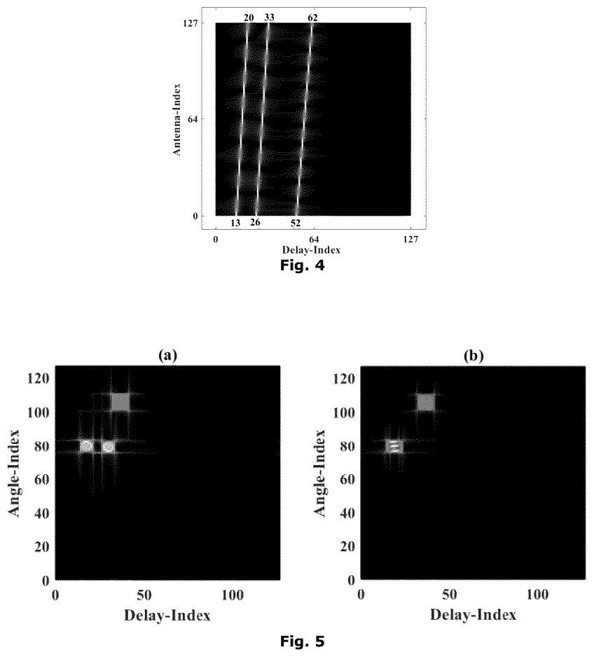

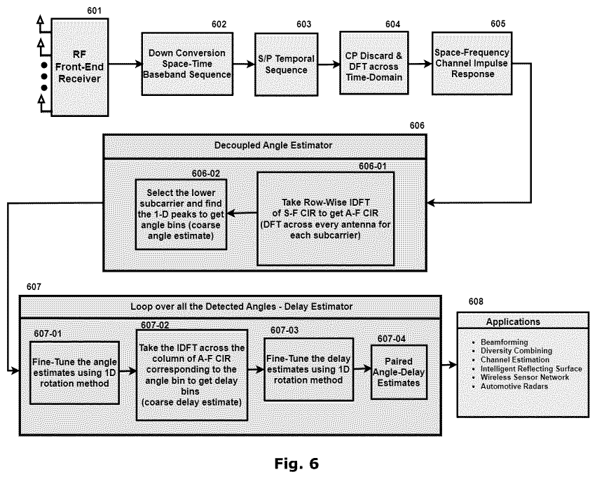

In the angle-delay domain, the channel is block sparse, and every physical path in H(θ, T) is orthogonal with others, which undergoes a square spread for the spatial wideband model. It is shown in FIG. 5 for the three paths spreading in a square region depending on their DoA. It can be seen from FIG. 5(a) that the three paths corresponding to the three point scatters are spread in the 2D delay-angle domain. Moreover, for a path distance which is reduced in delay by a less value, even if they are separate, yet due to the dual wideband effect, in the observed channel response these overlap and hence it is problematic to detect such overlapped paths. In this disclosure, we propose a decoupled strategy based on low-index detection to handle such conditions.

### Proposed Decoupled Path Detection and DoA-ToA Estimation

### Spatial Narrowband Scenario:

We can represent the spatial narrowband-temporal wideband model from (2) in a decoupled way. For this, we can start either from \tilde{θ}ₗ to \tilde{τ}ₗ direction or the other way round. We start from the \tilde{θ}ₗ direction first in order to visualize the decoupling idea. In the Angle-Delay (A-D) domain, there may be a few paths that have the same DoA with different ToAs; let there be a total I≤P number of distinct angular paths present. In such a condition, these few angular paths may have more than one delay path.

To detect these paths, we propose the decoupled detection algorithm for spatial narrowband-temporal wideband systems as shown in FIG. 6. The system includes conventional processing blocks from 601-605 and innovative decoupled angle estimator (606) and delay estimator (607). Once, we have the space-frequency CIR, we take the IDFT across all the rows (i.e., across the antenna domain to get the A-F CIR) as shown in 606-01. We pick a lower subcarrier index and find the bins corresponding to the peaks present in the spectrum for coarse angle estimates which is depicted in 606-02. Next, for each detected angle, we find the delay estimates using 607. We fine tune the detected angle via 1D rotation method (607-01). Then, we take the IDFT by picking the corresponding row from the angle-frequency CIR and detect the peaks in the delay spectrum to estimate the coarse delay bins from 607-02. Later, we fine tune the delays using 1D rotation method (607-03) and pair all the detected delays with the current angle (607-04). It should be noted that the proposed method has two main advantages
1. It has automatic paring of the decoupled estimated angle and delays.
2. Due to the use of only 1D rotation, the computational complexity is significantly reduced.

### Spatial Wideband Scenario:

We adopt the same decoupled strategy as in the spatial narrowband case for estimating DoAs followed by ToAs. With close observation, we find that at the low subcarrier index, the effect of beam-squinting can be ignored, and the DoAs are the same (up to the bin resolution) as the input paths. Similarly, the ToAs are squint-free for the lower antenna index and are the same as per the input paths.

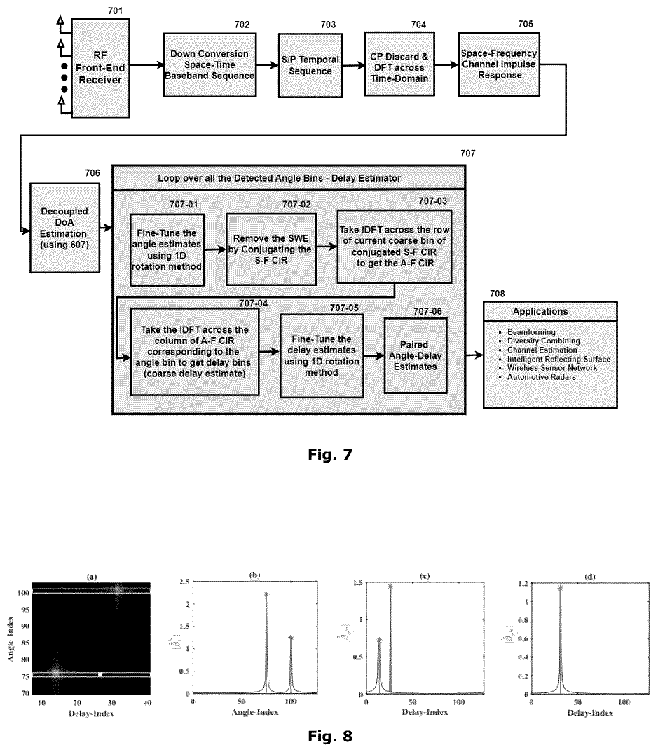

The proposed decoupling based DoA-ToA method is shown in FIG. 7 for the spatial wideband-temporal wideband (dual wideband) systems. The system is similar to the angle detection for the spatial narrowband systems except for the fact that to avoid the squinting effect, we have to use the lower antenna index (706). The main inventive contributions are in block-707 colored green in FIG. 7. For every detected angle bin, we get the fine-tuned angle estimate through 1D-rotation (707-01). Moreover, the fine-tuned angle estimate conjugates the spatial wideband effect very closely to get the correct DoA-ToA signatures (707-02). Once, we conjugate the space-frequency CIR, we get the wideband removed space-frequency response after which we take the IDFT across the row of the current angle bin to get the angle-frequency CIR (707-03). Later, we take the IDFT across the column of the detected angle bin and find the peaks for the coarse delay estimates (707-04). We implement the 1D rotation-based fine tuning for each delay (707-05) and pair them with the current angle (707-06). This procedure we repeat for all the detected angle bins from module 707 in FIG. 7.

The major advantage of picking the angle first is that we can remove the SWE very significantly due to the facility of estimating fine-tuned angle estimation via the rotation method.

### Test Example: Spatial Narrowband-Temporal Wideband

At first, we demonstrate the mechanism of the proposed decoupling-based method for the spatial narrowband case (α=0.001). We assume the grid size for this example is (N, R)=128. We consider a three path channel and assume the normalized input DoA-ToA of these paths are—(\tilde{θ}₁, \tilde{τ}₁)=(75.50/R, 13.50/N), (\tilde{θ}₂, \tilde{τ}₂)=(75.50/R, 26.00/N), and (\tilde{θ}₃, \tilde{τ}₃)=(100.25/R, 31.25/N).

We have shown the 2D delay-angle response in FIG. 8(a) and observe that the path-1 and path-2 lie in the same angle bin-75. Further, we find that at the angle bin-75, there are two different delay bins-13, 26 reflecting the two paths, and at the angle bin-100, there is one path with the delay bin-31 corresponding to the path-3. Next, we present the decoupling-based estimation of the three paths. In FIG. 8(b), we show the angular spectrum evaluated for the 0^{th} subcarrier, from which we can successfully detect the two peaks at 75 and 100 bin corresponding to the coarse estimates of the path angles. Once we find these coarse angle estimates, we can implement the 1D rotation to get the fine tuned angle estimates. Followed by this, we have to search only for these identified angular bins for the path delays, and hence, the automatic angle-delay coupling is available for all the paths. Further, the delay spectrum calculated at the angular bin-75 is depicted in FIG. 8(c) where the two peaks are observed at bin-13 and bin-26 that corresponds to the path-1 and path-2. Similarly, at the angular bin-100, the peak is at bin-31 as shown in FIG. 8(d) that corresponds to path-3.

### Test Example: Spatial Wideband-Temporal Wideband

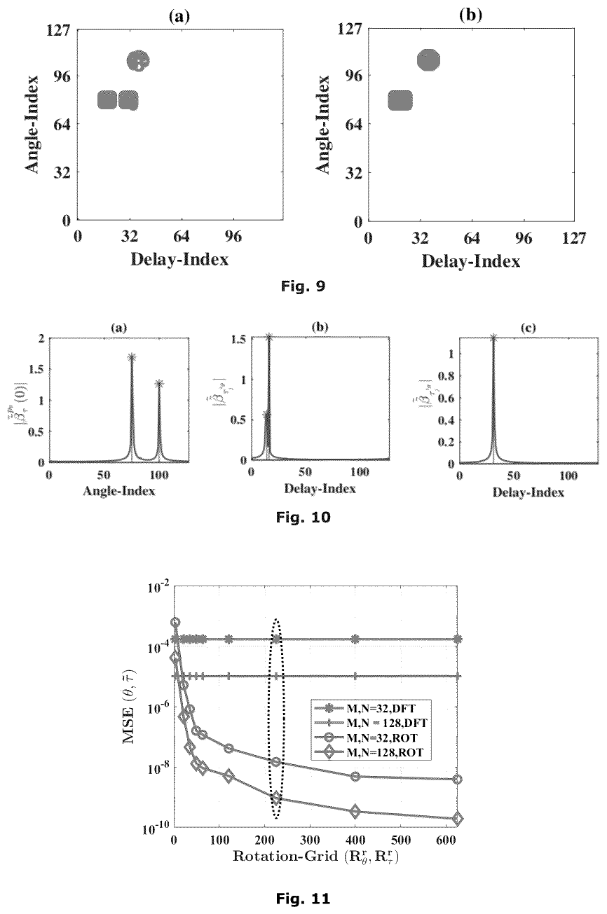

In a spatial wideband case (α=0.1), the channel paths are spread in the A-D domain as shown in FIG. 5. We can implement the 2D grid approach to identify the corresponding clusters and find the coarse estimate from each cluster, followed by a 2D rotation-based fine-tuning. However, if we let the path-2 ToA be \tilde{τ}₂=16/N, due to the dual wideband spread, path-1 and path-2 will overlap as shown in FIG. 5(b). In such a situation, methods implemented directly over the 2D grid cannot resolve these overlapped paths. As an example, if we implement the clustering approach we identify the three clusters in the non-overlapping case as shown in FIG. 9(a), whereas only two clusters are detected when the paths are overlapped due to the spatial wideband effect, as the same can be verified from FIG. 9(b).

With the proposed decoupling methodology, at first, we identify the two distinct DoAs from the angular spectrum evaluated at 0th subcarrier as shown in FIG. 10(a) followed by a 1D rotation-based fine-tuning of these coarse angles. Now, as we conjugate the spatial wideband effect by the estimated fine-tuned DoA for a particular angular path, it becomes equivalent to the spatial narrowband case for that angular path for which we can calculate the delay spectrum. For the first angular path, the angular spectrum is shown in FIG. 10(b), where we find the two peaks corresponding to the two close path ToAs. Hence, in the proposed decoupling method, we are able to identify the two close paths that are detected as a single cluster by the clustering method (In FIG. 9(b) the left cluster). Similarly, we remove the wideband effect for the second angular path and respectively evaluate the delay spectrum where we find one peak as depicted in FIG. 10(c).

### Results:

### Spatial Narrowband-Temporal Wideband System Performance:

First, we evaluate the average performance of rotation on a spatial narrowband system. We can see the effect of rotation grid points on the MSE of the signature estimate. We observe that the MSE in DoA-ToA is fixed around 10⁻⁴ when R, N=32 and around 10⁻⁵ when R, N=128 with the direct use of DFT as shown in FIG. 11. However, it can be observed with the increase in rotation grid points, the MSE in DoA-ToA keeps on reducing, which gives us enhanced accuracy.

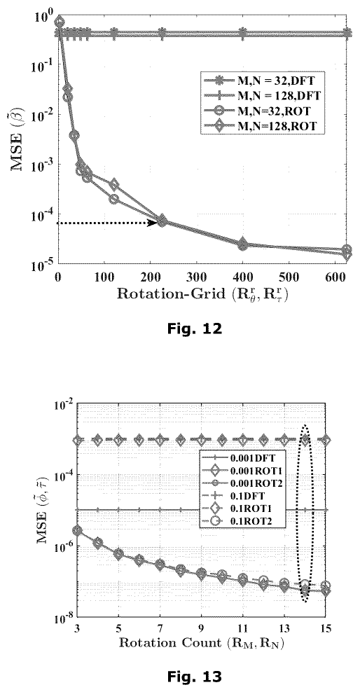

We can also identify the influence of rotation with high grid count in the precision of estimating the complex coefficients for each channel path. As shown in FIG. 12, the accuracy is limited to <10⁻¹ for the direct DFT, whereas it falls up to 10⁻⁵ with increasing grid points.

### Spatial Wideband-Temporal Wideband (Dual Wideband) System Performance:

Now, the performance evaluation is shown for the spatial wideband scenario. We evaluate the estimation MSE to depict the effectiveness of the proposed algorithm. We show the MSE for DoA-ToA estimation in FIG. 13. At α=0.001, the MSE in DoA-ToA is 10⁻⁵ due to spatial narrowband case and already high grid size i.e. R, N=128. Further, it can be seen that the MSE in DoA-ToA is reduced with increasing Rotation-grid when one-stage and two-stage rotation is used.

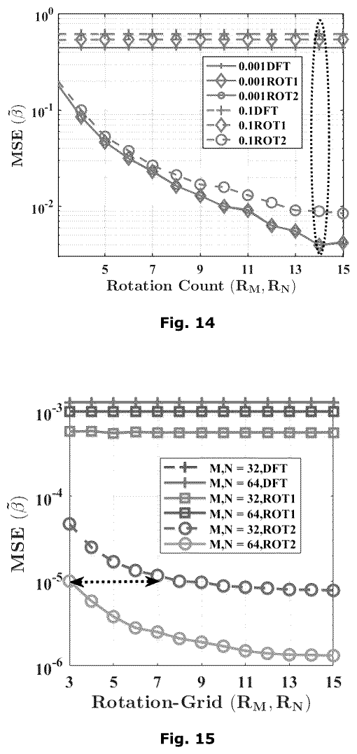

Next, we see the MSE in the path coefficient in FIG. 14. It can be seen that with the DFT, the MSE path coefficients are saturated to 0.5, which is quite inferior. We see that the MSE falls off very quickly to a great extent with the increase in the rotation grid. It is evident from simulation results in FIG. 12 that at a wider BW α=0.1, one-stage DFT is not capable of reducing the estimation error, whereas the proposed two-stage rotation in this work reduces the error equivalent to the narrowband case.

### Spatial Wideband-Temporal Wideband (Dual Wideband) System Performance:

At α=0.1 BW, we can see from FIG. 15 that the MSE in estimations accuracy for complex path coefficients decreases further with the significant increase in (M, N) measurement grid size at lesser rotation-grid numbers.

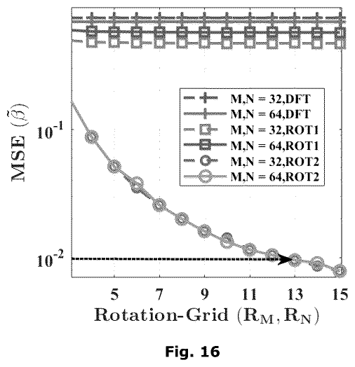

Similarly, at α=0.1, using two-stage rotation, we get the 10⁻² MSE in path coefficient estimates at R_{θr}, R_{τr}=13 with R, N=64 as shown in FIG. 16, whereas we get the same MSE at R_{θr}, R_{τ}=10 with R, N=128 given in FIG. 16.

Write: Importance of the method proposed is two folds
1. Detection of the number of scatters present in the channel
2. Estimating the accurate DoA-ToA parameters.

There is a chance that there can be two or more scatters at the same DoA with different ToAs or vice-versa. In estimating the DoA and ToA of the scatters present in the radio environment, first we need to detect them correctly. In this disclosure, we detect the targets independently on the angle dimension first, followed by the delay dimension for each detected angle and pair them. Simultaneously, we fine-tune the angle-delay signature via 1D-rotation technique that yields ultra-low complexity.

1. A method for low-complex estimation of Direction of Arrival (DoA) and Time of Arrival (ToA) in multi-antenna-based communication comprising
detecting overlapped paths between a Mobile Station (MS) and a Base Station (BS) operating under said multi-antenna-based communication with scatters present therein involving channel paths represented as Channel Impulse Response (CIR) defined with channel signatures including delay and angle steering vectors;
decoupling the channel paths in delay and angle-domain and separately estimate the DoA and ToA of each path with a low computational complexity which is based on one-dimensional low-index based rotation methodology; and
pairing the DoA and the ToA.

2. The method as claimed in claim 1, wherein the CIR is represented as:
for spatial narrowband-temporal wideband systems
$$H = {{\sum }_{l = 1}}^{L} {\tilde{β}}_{l} c ( {\tilde{θ}}_{l} ) d ( {\tilde{τ}}_{l} ) \qquad ( 1 )$$
where, \tilde{β}ₗ is the equivalent complex path gain; and
for spatial wideband-temporal wideband systems
$$H = {{\sum }_{l = 1}}^{L} {\tilde{β}}_{l} c ( {\tilde{θ}}_{l} ) d ( {\tilde{τ}}_{l} ) oS ( α , {\tilde{θ}}_{l} ) \qquad ( 2 )$$
where, α is the BW selection parameter around the carrier frequency and S(α, \tilde{θ}ₗ)≙
$$exp ( - j 2 π \frac{α}{N} {\tilde{θ}}_{l} rn )$$
is the wideband phase shift matrix and o denotes the element-wise product between matrix elements.

3. The method as claimed in claim 1, wherein the decoupling the channel paths includes
transforming the CIR into an angle-frequency domain by taking IDFT w.r.t. space domain (d) for the DoA estimates;
transforming the CIR into Space-Delay domain by taking IDFT w.r.t. frequency domain (n), which enables delay diversity combining and the ToA estimation.

4. The method as claimed in claim 1, wherein the decoupling the channel paths in spatial narrowband-temporal wideband model includes
involving the CIR which is in space-frequency domain and applying the IDFT across all rows i.e., across the antenna domain to get the A-F CIR;
picking a lower subcarrier index and finding bins corresponding to the peaks present in the spectrum for coarse DoA angle estimates;
fine tuning each detected DoA angle via 1D rotation method;
involving the IDFT by picking the corresponding row from the angle-frequency CIR and detecting the peaks in the delay spectrum to estimate the coarse ToA delay bins;
fine tuning the ToA delays using 1D rotation method and pair all the detected ToA delays with the DoA angle estimates.

5. The method as claimed in claim 1, wherein the decoupling the channel paths in spatial wideband model includes detection similar to the spatial narrowband-temporal wideband model except to avoid squinting effect by involving lower antenna index.

6. A system for low-complex estimation of Direction of Arrival (DoA) and Time of Arrival (ToA) in multi-antenna-based communication implementing the method as claimed in claim 1 in spatial narrowband scenario comprises
decoupled angle estimator (606) and delay estimator (607) configured to operate in combination with processing blocks (601-605) that provides the space-frequency CIR;
said decoupled angle estimator (606) includes
IDFT block (606-01) for IDFT across all the rows i.e., across the antenna domain to get the A-F CIR,
subcarrier indexing block (606-02) to pick a lower subcarrier index and find the bins corresponding to the peaks present in the IDFT spectrum for coarse angle estimates;
said delay estimator (607) which is configured for finding the delay estimates for each angle estimates includes
tuner block (607-01) to fine tune the detected angle estimates via 1D rotation method;
IDFT block (607-02) to take the IDFT by picking the corresponding row from the angle-frequency CIR and detect the peaks in the delay spectrum to estimate the coarse delay bins;
tuner block (607-03) to fine tune the delays using 1D rotation method; and
pairing block (607-04) to pair all the detected delays with the current angle.

7. A system for low-complex estimation of Direction of Arrival (DoA) and Time of Arrival (ToA) in multi-antenna-based communication implementing the method as claimed in claim 1 in spatial narrowband scenario comprises
processing blocks similar to the angle detection for the spatial narrowband along with lower antenna index block (706) to avoid squinting effect;
delay estimator (707) having
fine tuner block (707-01) to fine-tune angle estimate for every detected angle bin through 1D-rotation;
conjugating unit (707-02) for conjugating the fine-tuned angle estimate with the spatial wideband effect very closely to get correct DoA-ToA signatures which corresponds to wideband removed space-frequency response;
IDFT unit (707-03) to take the IDFT across the row of the current angle bin to get the angle-frequency CIR;
IDFT unit (707-04) to take the IDFT across the column of the detected angle bin and find the peaks for the coarse delay estimates;
fine tuner (707-05) to implement the 1D rotation-based fine tuning for each delay; and
pairing unit (707-06) for pairing the fine-tuned delay with the current angle.
